(19) United States
(12) Patent Application Publication
(10) Pub. No.: US 2002/0178310 A1
(43) Pub. Date: Nov. 28, 2002

(54) USB transmission control circuit

(76) Inventor: Akihiro Nozaki, Kanagawa (JP)

Correspondence Address: McGinn & Gibb, PLLC, Suite 200, 8321 Old Courthouse Road, Vienna, VA, 22182-3817, US

(21) Appl. No.: 10/150,969

(22) Filed: May 21, 2002

(30) Foreign Application Priority Data
May 22, 2001 (JP) 152183/2001

(51) Int. Cl. G06F 12/00; G06F 13/14; G06F 13/38

(52) U.S. Cl. 710/240

(57) ABSTRACT

A USB transmission control circuit of the present invention includes: a USB data control unit, which outputs transmission data to a USB bus; a USB transmission scheduler circuit, which designates the USB data control unit to perform transmission; FIFO memory, which stores data from an external memory; a FIFO controller, which controls the FIFO memory; a bus arbiter, which performs bus usage arbitration; a DMA controller; calculation means for calculating the difference between the amount of data written into FIFO memory by the FIFO controller and the amount of data sent out to the USB bus; and transmission means for commencing data transmission to the USB bus in conformity with an acknowledge signal from the bus arbiter, which authorizes bus usage, in response to a DMA request for writing data into FIFO memory.

### BACKGROUND OF THE INVENTION

1. Field of the Invention

The present invention relates to a USB transmission control circuit comprising a DMA controller and FIFO memory.

2. Description of the Prior Art

In recent years, due to the ease with which they allow computer peripherals to be connected, Universal Serial Bus (USB) devices utilizing a USB have quickly become popularized. Since the number of devices attached to one USB port has also increased, demands have been made for DMA control, FIFO memory control, and transmission scheduling management providing efficient data transfer to the plurality of attached devices.

These USB devices are effective in the respect that they facilitate current PC interface integration, they allow personal computer peripherals to be connected with ease even for beginners, and they also allow connection/disconnection to be made even when power is on, and are also effective in fields such as mobile terminals and PC cards where particularly low power consumption is desired. Moreover, they are particularly effective and as a method allowing efficient usage of USB buses with low power usage, considering USB, UART, PCMCIA are used in a Bluetooth wireless system as interfaces between Bluetooth hardware and a host.

In the case where a system is equipped with this USB, there are problems such as 1) increased power consumption and higher costs due to the mounting of memory capable of high speed access within the system in an attempt to increase transmission speed; 2) expanded substrate surface area and increased power consumption due to an increase in the number of buses as a result of increasing the bit size of the system bus in an attempt to increase transmission speed; and 3) expanded chip size and higher costs due to increased power consumption and expanded FIFO size because of higher system clock operating speed.

Such USB transmission control circuits generally comprise a DMA controller for importing data from external memory into the circuit and FIFO memory for storing data read in through the DMA operation, and are nearly always used for executing data transfer.

In order to respond to these demands, there is a method of performing high speed data transfer by providing a synchronous first-in first-out memory (hereafter referred to as FIFO memory), which stores transmission data, and a counter, which calculates the difference between the amount of data written into FIFO memory and the amount of data read out, for example as disclosed in Japanese Patent Application Laid-Open No. Hei 8-70359 (Conventional Example 1). In addition, a method has been proposed which provides a DMA controllable FIFO memory and performs burst-mode transfer, as disclosed in Japanese Patent Application Laid-Open No. Hei 11-134394 (Conventional Example 2).

A block diagram of this Conventional Example 1 is shown in FIG. 17. In FIG. 17, data delivery unit 2 comprises, in addition to FIFO memory 11, a counter (difference in data amounts calculation means) 12, which calculates the difference in the amount of data written into the FIFO memory from an input/output processing unit (input/output processing means) 1 and the amount of data read from FIFO memory 11 into data processing unit 3; the CPU on the data processing unit 3 side detects, with arbitrary timing, the amount of data in FIFO memory 11 from the value of the counter 12, and either in burst mode consecutively reads in data from synchronous first-in first-out memory 11 or in DMA mode causes the DMA controller to read out the data from FIFO memory.

This input/output processing unit 1 is assumed to be a DMA controller, which causes data from an external memory to be written into FIFO memory 11, and a data control unit 3, which is a data output processing unit to the USB bus. The data processing unit 3, or a USB bus data processing unit, operates with arbitrary timing to bring data into the FIFO 11 and output the data onto the USB bus. Accordingly, it is conceivable that the USB bus data processing unit 3 may divide a block of data in memory into a plurality of times, transmitting them. FIG. 18 and FIG. 19 are layout diagrams showing the detailed configuration of a typical USB packet. In this case, a packet includes a token phase, data phase, and handshake phase. The header portion (token phase) of this packet includes an 8-bit synchronizing pattern (SYNC), an 8-bit transmission type (PID), a 7-bit address (ADR) for the destination device, a 4-bit endpoint (EP) showing the end of the device, and a 4-bit check code (CRC) appended to the end of the device data. The data phase includes a similar synchronizing pattern (SYNC), a transmission type (PID), between 0 and 1023 bits of transmission data, and a 16-bit check code (CRC). The handshake phase includes a synchronizing pattern (SYNC) and the transmission type (PID).

In addition, as shown in FIG. 19, transmission of one USB packet includes one each of a token phase, a data phase, and a handshake phase, and uses (8×N+80) bit time. Transmission that is divided into two USB packets uses (8×B+160) bit time. It is noted that this is not the actual data, and since transmission is performed by dividing a block of data into a plurality of packets, there are problems such as the amount of data besides the actual data increasing and reducing the efficiency of data transfer.

A block diagram of Conventional Example 2 is shown in FIG. 20. In FIG. 20, a DMA controllable FIFO 112, which has two 32-byte FIFOs with one end connected to a 32 bit data bus 123a and the other end to a 16 bit data bus 122a, and a FIFO control unit including a DMA control function, receives data through DMA transfer processing from an I/O device 113 to one of the FIFOs in conformity with a DMA request (REQ-B). The other FIFO loads the received data into the first FIFO after receiving one DMA transfer burst length of data. After the first FIFO has accepted the data, in conformity with the DMA request (REQ-A) from the DMA controllable FIFO 112, the DMAC 104a receives data from the first FIFO through the DMA transfer operation. As the first FIFO is transmitting data to the DMAC 104a, the I/O device 113 is transmitting the next data to the other FIFO.

In this case, the I/O device 113 is assumed to perform data output processing to external memory 102a and the system controller 111 to the USB bus 122a. The system controller 131, or the USB bus data processing unit, does not perform any processing until the one DMA transfer burst length of data is written into FIFO; accordingly, problems develop such as the fact that the amount of idle time upon the USB bus when data transfer is not taking place increases and the fact that transfer efficiency decreases.

Transfer efficiency obtained through such USB transmission control has generally been increased by making the FIFO memory size larger and using external memory, which has a higher access time; however, in the field of mobile (phone) terminals, PC cards, and the like, USB devices have become popular and there are demands for configuration of USB systems having low power consumption, low capacity of FIFO memory, and efficient actual data transfer.

As mentioned above in Conventional Example 1 where conventional techniques are used for a USB transmission control unit, transmission with a plurality of packets divided as in FIG. 19 develops problems such as the amount of data besides the actual data increasing and reducing the efficiency of data transfer.

In addition, in Conventional Example 2, as in FIG. 21, problems develop such as the amount of idle time upon the USB bus 122a when data transfer is not taking place increasing and transfer efficiency decreasing. Furthermore, for the USB bus data processing unit, since a method is used where all of the data of one DMA transfer burst length is written into FIFO memory and the maximum data length for the USB is 1023 bytes, when this method is used, the internal circuit needs to include FIFO memory greater than 1023 bits. As a result, there are also problems such as LSI chip size increasing.

Moreover, a method where all of the data of one DMA transfer burst length is written into the FIFO memory is used for USB bus data processing unit; however, since the maximum length of data for the USB is 1023 bytes, when this method is used, the internal circuit needs to include FIFO memory greater than 1023 bytes, which therefore leads to problems linked to LSI chip size increasing.

### BRIEF SUMMARY OF THE INVENTION

Objects of the Invention

The object of the present invention is to provide a USB transmission control circuit that efficiently uses a USB bus by 1) curtailing the idle state upon the USB bus with an efficient and small FIFO size and 2) curtailing the header portion besides the actual data in the USB packet and the number of times check codes are transmitted, in particular in a system where high speed accessible memory cannot be mounted, and in a system where, since increasing the number of bits allowable over the system bus is difficult, it is impossible to increase the operating speed of the system clock.

### SUMMARY OF THE INVENTION

A USB transmission control circuit of the present invention includes: a USB data control unit, which outputs transmission data to a USB bus; a USB transmission scheduler circuit, which designates the USB data control unit to perform transmission; FIFO memory, which stores data from an external memory; a FIFO controller, which controls the FIFO memory; a bus arbiter, which performs bus usage arbitration; a DMA controller; calculation means for calculating the difference between the amount of data written into FIFO memory by the FIFO controller and the amount of data sent out to the USB bus; and transmission means for commencing data transmission to the USB bus in conformity with an acknowledge signal from the bus arbiter, which authorizes bus usage, in response to a DMA request for writing data into FIFO memory.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is a block diagram of a USB transmission control device for describing a first embodiment of the present invention;

FIG. 2 is a flowchart describing USB transmission control in FIG. 1;

FIG. 3 is a timing chart describing USB transmission control in FIG. 1;

FIG. 4 is a flowchart describing operation of the DMAC in FIG. 1;

FIG. 5 is a block diagram of the portion of the FIFO controller in FIG. 1;

FIG. 6 is a flowchart describing operation of the FIFO controller in FIG. 4;

FIG. 7 is a timing chart describing operation of the FIFO controller in FIG. 4;

FIG. 8 is a flowchart describing operation of the USB scheduler in FIG. 1;

FIG. 9 is a timing chart describing the results of USB transmission control in FIG. 1;

FIG. 10 is a timing chart describing USB transmission control according to a second embodiment of the present invention;

FIG. 11 is a timing chart describing the results of USB transmission control in FIG. 10;

FIG. 12 is a block diagram of a USB transmission control according to a third embodiment of the present invention;

FIG. 13 is a flowchart describing USB transmission control in FIG. 12;

FIG. 14 is a flowchart describing operation of a USB scheduler according to the third embodiment of the present invention;

FIG. 15 is a timing chart describing the results of USB transmission control in FIG. 14;

FIG. 16 is a timing chart describing another result of USB transmission control in FIG. 14;

FIG. 17 is a block diagram describing a conventional example of USB transmission control;

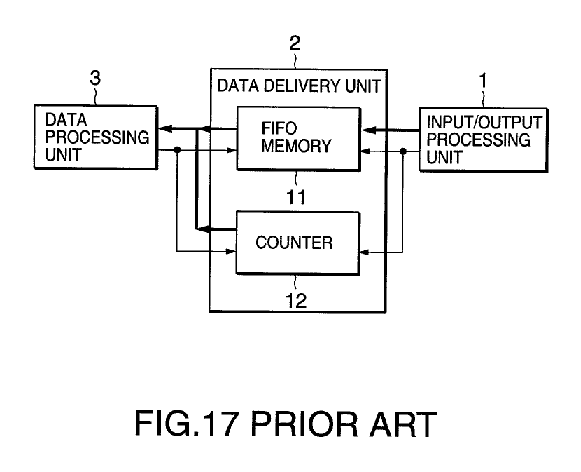

FIG. 18 is a layout diagram describing a packet for the conventional example of USB transmission control;

FIG. 19 is a layout diagram describing a packet for the conventional example of USB transmission control;

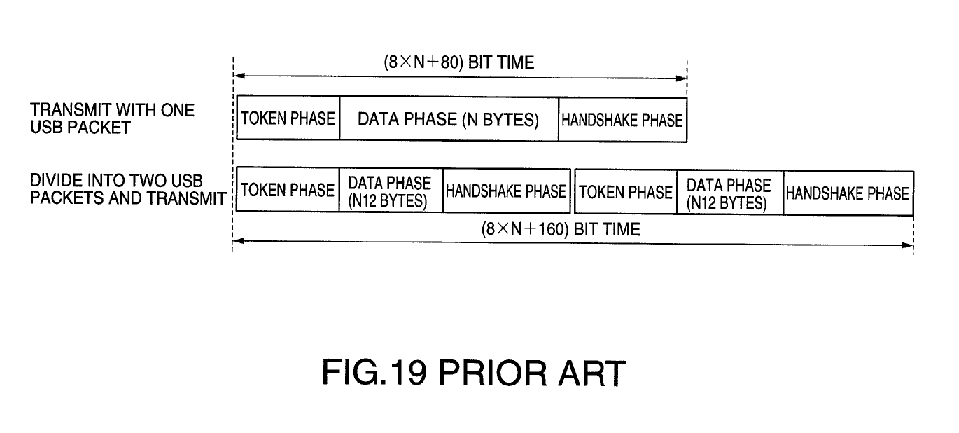

FIG. 20 is a block diagram describing another conventional example of USB transmission control; and

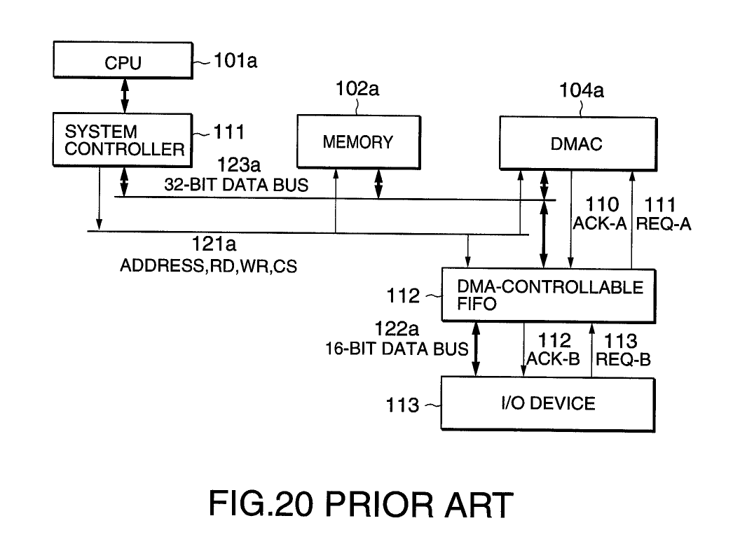

FIG. 21 is a timing chart describing the results of USB transmission control in FIG. 20.

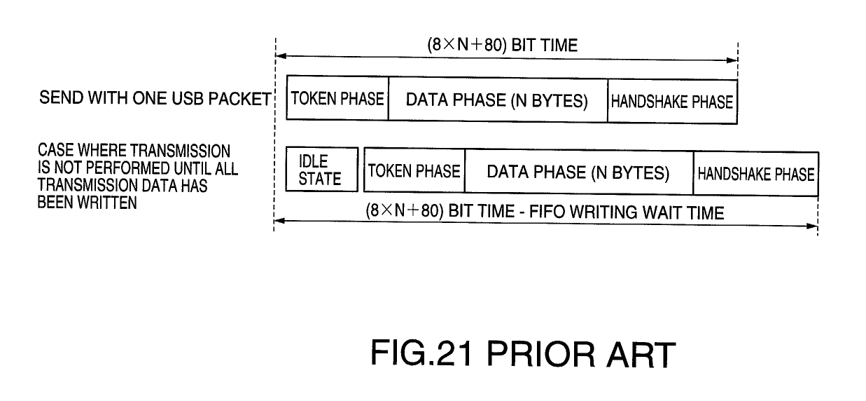

### DETAILED DESCRIPTION OF THE INVENTION

The present invention is described forthwith while referencing the drawings.

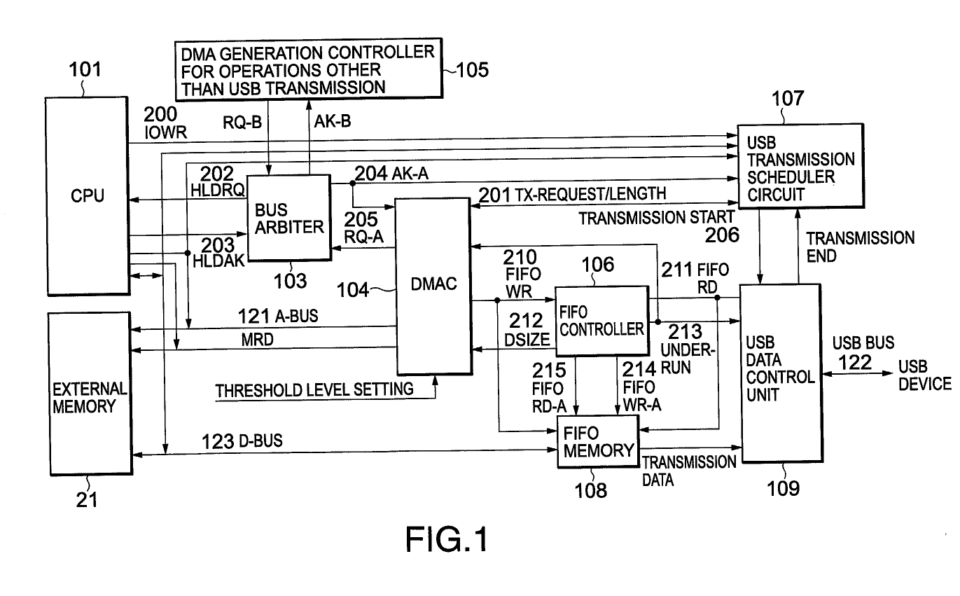

FIG. 1 is a block diagram of an embodiment of the present invention. According to FIG. 1, the configuration of USB transmission control includes a bus arbiter 103, USB transmission scheduler 107, USB data control circuit 109, and DMA controller 105 that operates for except for USB transmission, in addition to the CPU 101, external memory 102, DMAC (controller) 104, FIFO controller 106, and FIFO memory 108 included in Conventional Example 102. More specifically, in comparison with the conventional USB transmission control circuit configuration, the present invention provides a configuration where the USB transmission scheduler 107 imports an acknowledge signal AK-A 204 from the bus arbiter 103, and the USB data control circuit 109 imports an under-run signal 213 from the FIFO controller 106.

This acknowledge signal AK-A 204 denotes the fact that usage rights for the system buses A-BUS 121 and D-BUS 123 have changed from the CPU 101 to the DMAC 104. Using this signal, the USB transmission scheduler 107 gives a transmission start signal 206 to USB data control unit 109. This allows operation relating to the commencement of data transmission over the USB bus to be carried out.

Accordingly, while conventionally the idle state upon the USB bus when data is not output continues until a fixed amount of data is written in FIFO memory 108 by DMAC 104 in response to a data transmission request from the CPU 101, data transmission can be begun upon the USB bus simultaneous to the changing of the usage rights for system buses A-BUS 121 and D-BUS 123, thereby providing a result in decreasing said idle time on the USB bus.

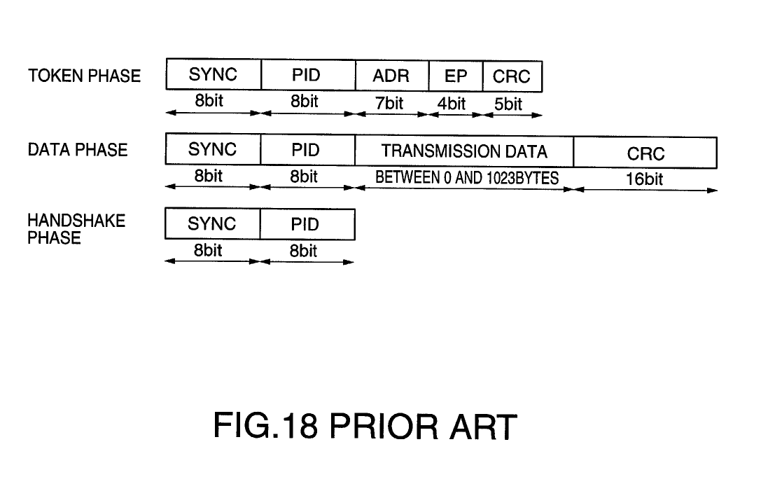

The configuration of a USB packet, as in the aforementioned FIG. 18, includes the following three group of data: 1) a token phase, 2) a data phase, and 3) a handshake phase. Of these three, 1) denotes the device and type of transmission, 2) is the actual data, and 3) confirms whether normal data transmission has been performed. From this it can be understood that the time period before the actual data is transmitted over the USB bus is a total of a 48-bit time period (equivalent to approximately 4 μs), or a 32-bit time period of the token phase plus a 16-bit time period for the data phase header. Accordingly, with the structure in FIG. 1, even in the case where the transmitted data is not written into transmission FIFO memory 108, it becomes possible to perform normal data transmission as long as the token phase commences upon the USB bus and data is written in transmission FIFO memory 108 before a period of 48-bit time has passed.

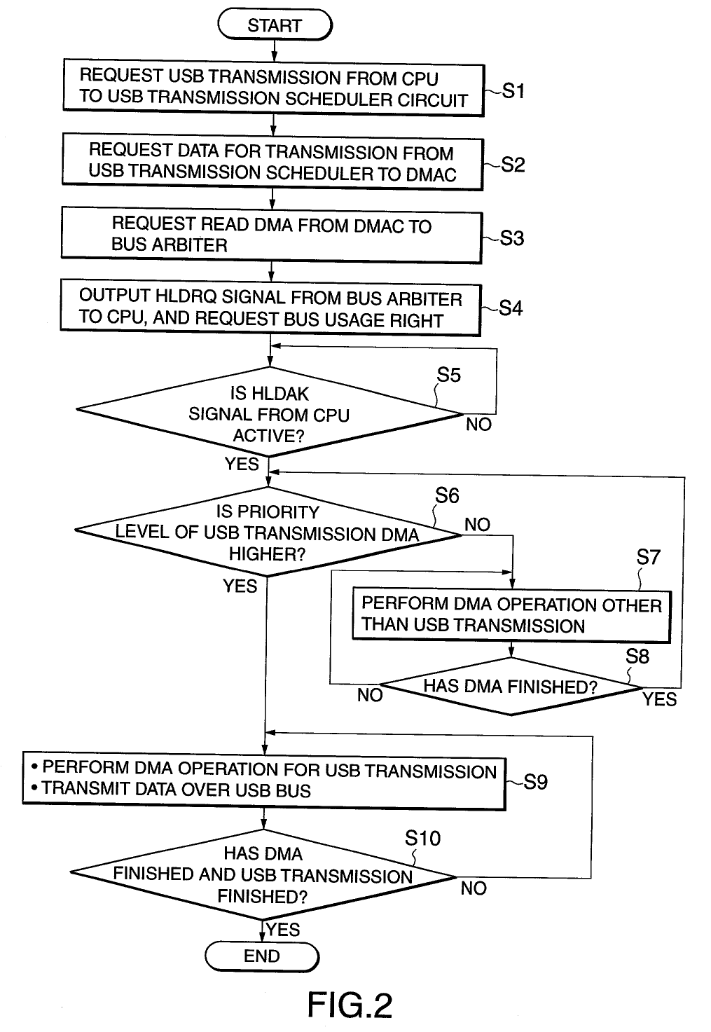

FIG. 1 shows the USB host side transmission control circuit configuration. In this USB host side transmission control circuit, an acknowledge signal AK-A 204 is coupled to the USB scheduler 107 and an under-run signal 213 to the USB data control unit 109. The overall operational flow of this USB host side transmission control is shown in FIG. 2. The operation of the circuit shown in FIG. 1 is described in accordance with this flow.

To begin with, once the data to be sent out to the USB bus 122 has been prepared in the external memory 102, in Step S1, the CPU 101 designates for the USB transmission scheduler circuit 107 the length of data to be transmitted and gives a command for transmission activation. The USB transmission scheduler circuit 107 administers whether or not there is data present on the USB bus 122. If there is no data present upon the USB bus 122, in Step S2, the DMA request signal (201) TX-REQUEST and the data length LENGTH are supplied to the DMAC 104. This allows the DMAC 104, in Step S3, to supply a bus usage request signal RQ-A 205 to the bus arbiter 103. In Step S4, the bus arbiter 103 performs arbitration with other bus usage requests besides the bus usage request signal RQ-A 205 and supplies a bus request signal HLDRQ 202 to the CPU 101, which acts as the bus master.

In Step S5, a HLDAK signal 203, which authorizes bus usage is supplied from the CPU 101, and then from the bus arbiter 103, an AK-A signal 204, which shows that bus usage has been authorized, is supplied to DMAC 104 and USB transmission scheduler circuit 107 (Steps S7 and S8). In response to this processing signal, the USB transmission scheduler circuit 107, which is the feature of the present invention, in Step S9, supplies a transmission start signal 206 to USB data control unit 109 and data is transmitted over USB bus 122. In parallel with this, DMAC 104 transfers in bursts data written in external memory 102 to FIFO memory 108.

The data obtained in such a manner as described above is then supplied to USB data control unit 109, and after completion of the token phase upon the USB bus 122, is output as data phase transmission data onto the USB bus (Step S9). Once transmission for the data length set by the CPU 101 has been completed (Step S10), processing proceeds to the handshake phase, preparing for the subsequent data transmission.

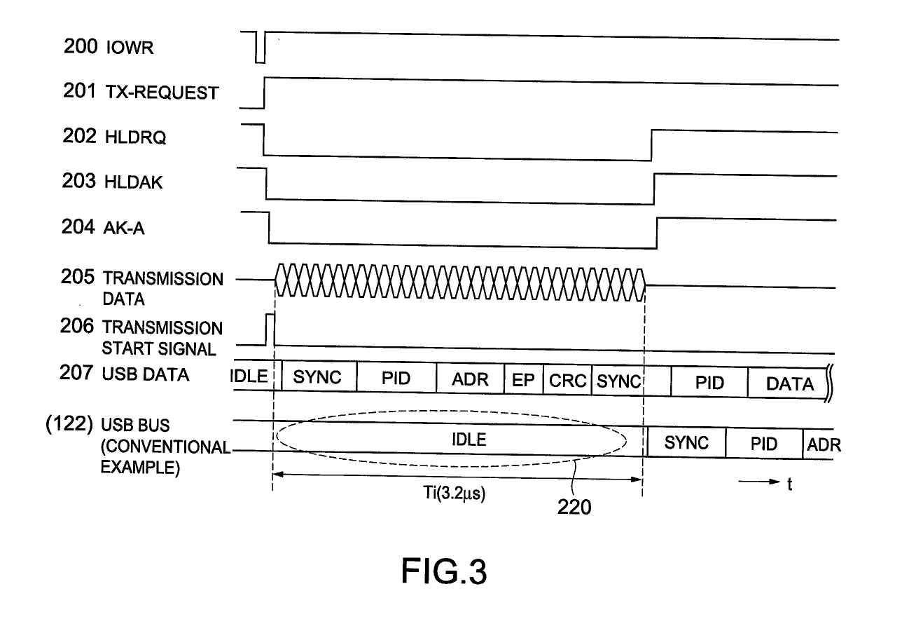

Next, the operational waveform of this embodiment is described using the timing chart in FIG. 3. To begin with, the operation of the USB host transmission control circuit shown in FIG. 1, in the case of the bit width of a data bus D-BUS 123 being 16, an external memory 102 with a size of 64 bytes, and access time of 100 ns being used for FIFO memory 108, is described. To begin with, when the CPU 101 makes the transmission request to the USB transmission scheduler circuit 107, transmission operation is commenced. The timing of this correlates to the change in the IOWR signal 200 in FIG. 3. Thereafter, a DMA request 201 is sent from the USB signal scheduler 107 to the DMAC 104, and through the handshake between the bus arbiter 103, which issues a bus usage request signal 202, and the CPU 101, which issues a grant signal 203, an AK-A signal 204, which shows that bus usage has been granted, is output from the bus arbiter 103 to the DMAC 104 and the USB transmission scheduler 107. In response to this signal, data in the external memory 102 is written into FIFO memory 108 by the DMAC 104 and the FIFO controller 106. In parallel with this, a transmission start signal 206 is generated inside the USB transmission scheduler 107, and USB data 207 is sent out to the USB bus 122 by the USB data control unit 109.

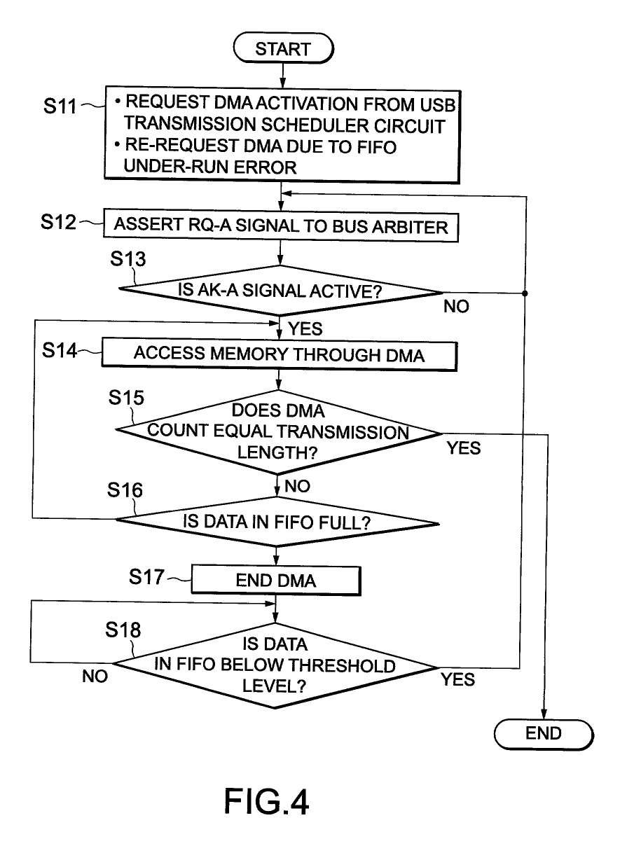

Next, the operational flow of the DMAC 104 of FIG. 1 is shown in FIG. 4. It is noted that the operation of this DMAC 104 is well known to persons with ordinary skill in the art. To begin with, in Step S11, once there is a DMA activation request from the USB transmission scheduler 107 or a DMA re-request due to a FIFO under-run error, in Step S12, a RQ-A signal 205 is asserted to the bus arbiter 103. In Step S13, if an AK-A signal 204, which shows bus usage rights, is supplied, then a read address for the external memory 102 is supplied to the A-BUS 121, and a data read signal is supplied to the MRD. The DMAC 104 monitors a DSIZE signal 212 showing the data size within FIFO memory 108 that is supplied from the FIFO controller 106, and in Step S18, if data in FIFO memory 108 becomes full, supply of the DMA request signal RQ-A 205 is temporarily halted.

The threshold level of the DMAC 104 is set so that if the data size within FIFO memory 108 is lower than the threshold level (Step S18), processing returns to Step S12, where an RQ-A signal 205 is once again supplied to the bus arbiter 103, and if an AK-A signal 204 showing bus usage rights is supplied, then the operation where a read address for the external memory 102 is supplied to the A-BUS 121 and a data read signal is supplied to the MRD is repeated. During DMA operation, if the DMA operation for the data length supplied from the USB scheduler has ended (Step S17), supply of the BQ-A signal 205 is temporarily halted.

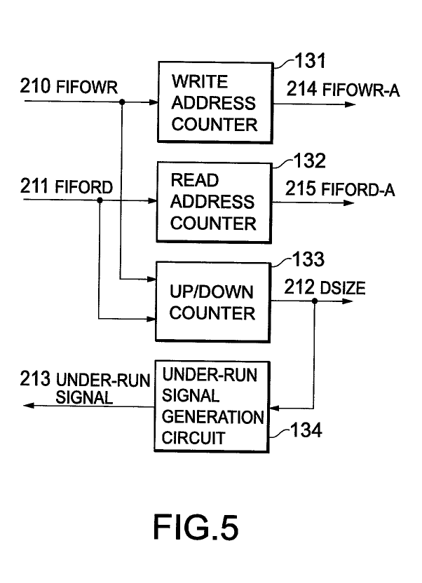

A detailed block diagram of the FIFO controller 106 in FIG. 1 is shown in FIG. 5. In FIG. 5, the DMAC 104 includes a write address counter 131, which generates a write address for FIFO memory 108 and, if a write-in signal FIFOWR 210 is detected, increments that write address; a read address counter 132, which generates a read address for FIFO memory 108 and, if a read-out signal FIFORD 211 from the FIFO has been detected, increments that read address; an up/down address counter 133, which determines the data count of the FIFO memory and, if the write-in signal FIFOWR 201 is detected, increments that counter value; and a under-run generating circuit 134, which, if the data count of the FIFO memory generated by the up/down address counter 133 becomes a negative value (i.e., the read data count becomes greater than the write data count), activates an under-run signal 213. These allow the data count (i.e., the difference between the write data count and the read data count) of the FIFO to be determined.

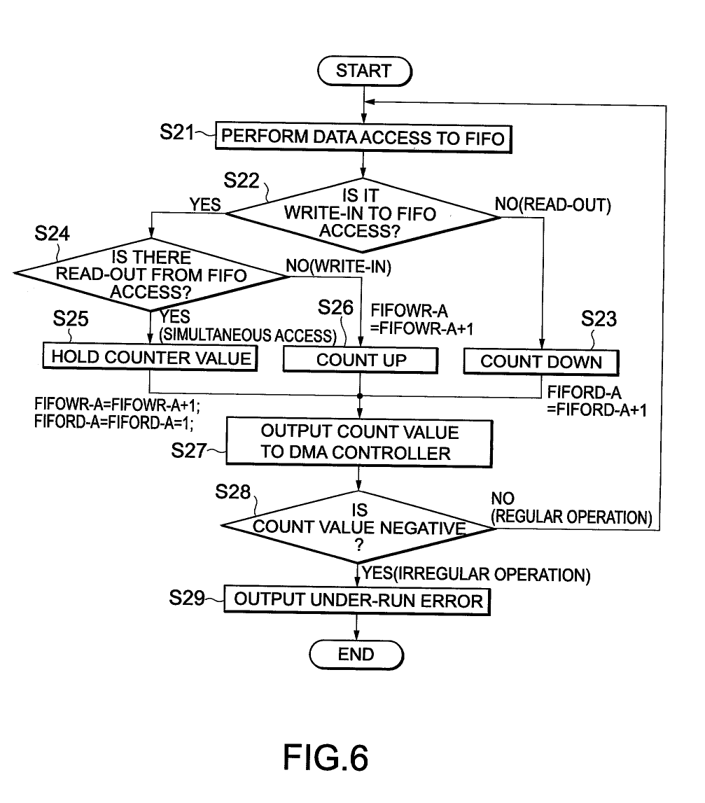

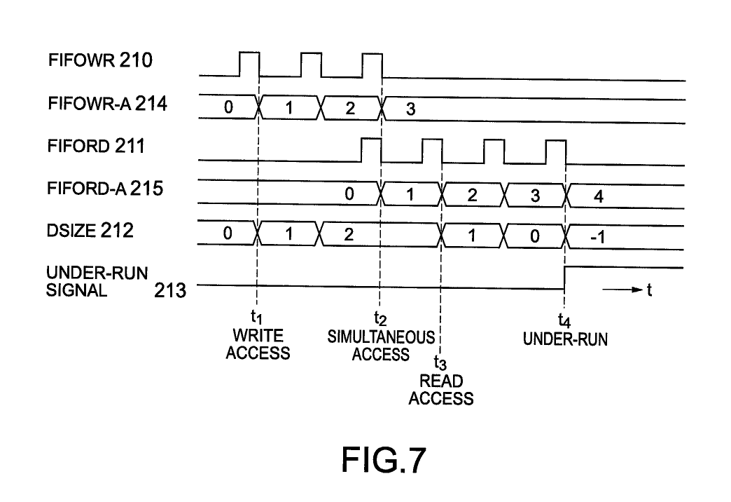

FIG. 6 is a flowchart describing the operation of the FIFO controller shown in FIG. 5, and FIG. 7 is a timing chart describing that operation. To begin with, in the case where data access to the FIFO occurs (i.e., a FIFOWR signal or a FIFORD signal occurs) (Step S21), it is determined whether that access is a write access (Step S22), and if it is a write access, it is further determined in Step S23 whether there is a read access. In the case where this is not a read access, as in Step S26, the write access-counter 131 increments the FIFO write address FIFOWR-A214 (FIFOWR-A=FIFOWR-A+1), and increments the output signal DSIZE of the up/down counter 133 (write access t1 in FIG. 7).

In addition, in the case where it is determined in Step S24 that there is a read access, i.e., in the case where write access and read access has occurred simultaneously (Step S25), and FIFOWR-A and FIFORD-A are respectively incremented by adding one (+1) to the write address counter 131 and the read address counter 132 so that the value of up/down counter 133 does not change (simultaneous access t2 in FIG. 7). In addition, in Step S22, in the case where there is no write access to the FIFO memory, the read address counter 132 is increased by one in Step S23 (FIFORD-A=FIFORD-A+1), and the output signal DSIZE of up/down counter 133 is decremented (read access t3 in FIG. 7).

After this processing, in Step S27, the count value of up/down counter 133 is output to the DMAC 105, determination is made whether the value DSIZE of up/down counter 133 is negative (Step S28), and in the case where it has become a negative number (or the FIFO is in under-run mode) (Step S29: under-run t4 in FIG. 7), an under-run signal 213 is output from an under-run generation circuit 134.

With this manner of USB packet transmission, once an instance of data transmission has commenced upon the USB bus 122, data requests are consecutively generated for the arbitrary number of pieces of data from the USB data control circuit 209. Accordingly, in the case where the DMA, which performs data writing into the FIFO, is held up for any reason, a FIFO data read is considered to develop for an address in the FIFO where data writing has not been performed. The fact that this condition has developed is perceived from the fact that the DSIZE 212 of the up/down counter 133, which shows the data count within the FIFO, has become a negative number, and an under-run signal is generated.

It is noted that in the case where an under-run signal is generated, the under-run signal 213 of FIFO memory 108 that is generated within the controller is supplied to the USB data control circuit 109, thereby causing a bit stuff error to develop upon the USB bus 122; and by supplying it to the DMAC 104, DMA is performed again to retransmit the USB data.

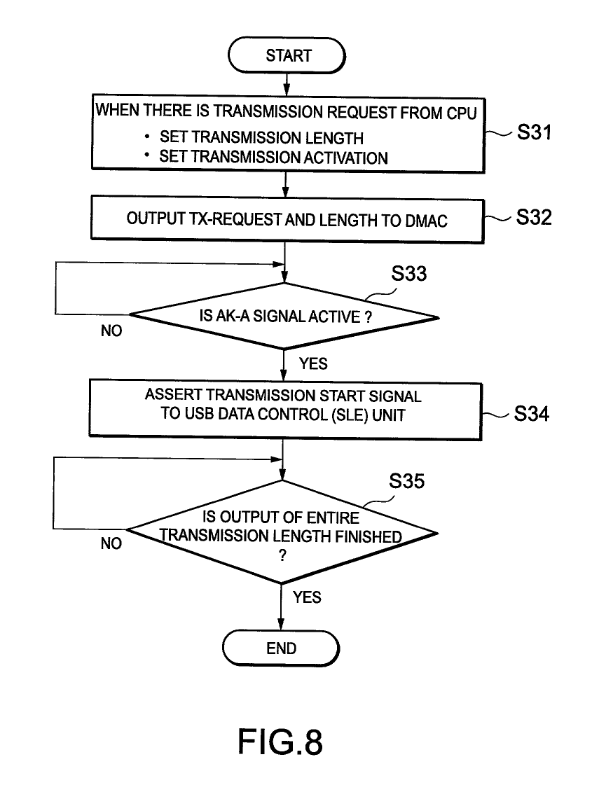

The operational flow of the USB scheduler 107 of FIG. 1 is shown in FIG. 8. To begin with, in Step S31, registers included in the USB scheduler circuit 107 for the transmission data length and transmit initiation trigger are set using the D-BUS 123 and A-BUS 121, which are a system bus, and write signal IOWR. The USB scheduler circuit 107 has the function of monitoring the existence of data upon the USB bus, and if there is no data upon the USB bus, a DMA request signal TX-REQUEST and a data length LENGTH are supplied to the DMAC 104 (Step S32). After bus arbitration by the bus arbiter 103, in Step S33, once the AK-A signal, which authorizes bus usage, is supplied, the USB scheduler circuit 107 supplies a transmission start signal 206 to the USB data control 109 (Step S34). Once transmission is activated in response to the AK-A signal, and the USB scheduler circuit 107 does not supply the next data transmit grant signal to the USB data control unit 109 until a transmission end signal has been supplied from the USB data control 109 (in Step S35).

The USB data control unit 109 of FIG. 1 is well known to those skilled in the art, thus detailed description is hereby omitted. This USB data control unit 109 is a component which acts as a Serial Interface Engine (SIE) to generate the USB transmit packet shown in FIG. 18 and extract the actual data other than the control data from the USB receive packet. On the transmission side, the main functions are to generate the token phase, transmit data, generate handshake phases, and process errors; meanwhile, on the reception side, the main functions are to extract the actual data other than the control data, and process errors. With the USB transmission packet generating unit within this USB data control unit 109, it has a function which inserts an error (a bit stuff error) within the transmission packet during transmitting data, and once a USB packet including this error is received, this reception packet is discarded by the reception side USB control section. Accordingly, when the USB transmission control circuit supplies the transmission data to the SIE macro, in the case where some sort of error has developed and the transmission thereof should be interrupted, request to the USB data-control unit 109 to generate a bit stuff error allows transmission to be interrupted and after the transmission interruption, the same data is re-sent all over again from the start.

With this embodiment, USB transmission commencement timing is made to correlate to detection of the acknowledge signal 204 from the bus arbiter 103 that corresponds to the DMA request for writing USB transmission data into the FIFO 108. At this USB transmission start time, transmission data is not actually written into the FIFO 108 yet.

Through the bus arbiter 103, arbitration is performed with other DMA requests from the DMA controller 105 for operations other than USB transmission, and through the DMA transmission, if a higher priority DMA request develops, there are cases where processing of the DMA transmission stops partway through and the higher priority DMA is executed.

With the USB transmission block within the USB data control unit (SIE), data is consecutively read in from the FIFO 108 to generate USB packets transmitting data once transmission has been activated. Accordingly, for some reason, in the case when data writing into the FIFO 108 is delayed, there is a possibility that the FIFO 108 will under-run. This under-run signal 213 is detected from the FIFO controller 106 and supplied to the USB data control unit 109. At this point, using the function of the USB data control unit that inserts an error (bit stuff error) into the transmission packet, packet transmission is interrupted, and data is resent to allow normal data transmission upon the USB bus 122 to be performed.

The feature of this embodiment is described forthwith using the timing chart in the earlier described FIG. 3. This is a comparison of the data on the USB bus in the case where conventional transmission control is used vis-à-vis the case of this embodiment. The idle portion 220 of FIG. 3 denotes a section in the idle state of the USB bus that develops due to waiting for data writing in FIFO memory 108. With this embodiment, it is shown that the USB bus idle state (220) T1 of the conventional example is 3.2 ps, but it can be understood that the USB bus idle state 220 does not exist.

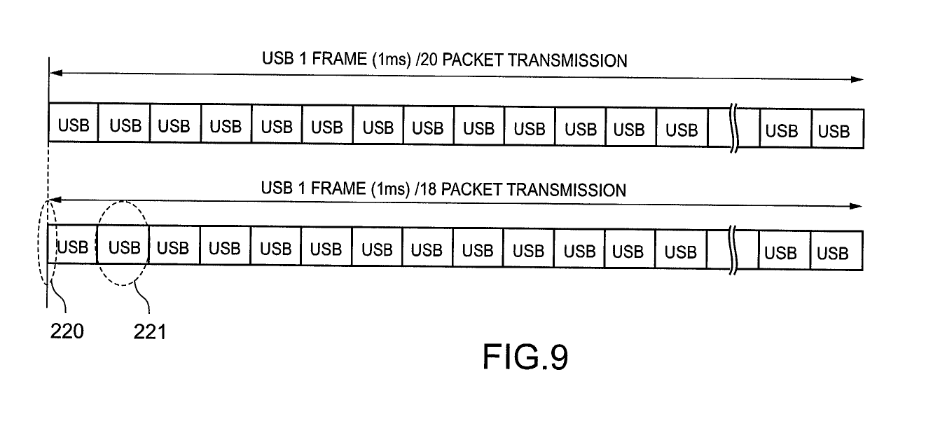

Moreover, FIG. 9 shows a timing chart where comparison between the transmissions with this embodiment and the conventional example is made in terms of how much data can be transmitted within one frame (1 ms) through the USB. In this figure, the transmission data length of one USB packet is given as 64 bytes, and immediately after data transmission upon the USB bus is completed, a comparison of the case where the next transmission is activated is performed. In FIG. 9, the USB bus idle state 220 and a 64-byte USB packet 221 are shown. From FIG. 9, it can be understood that in the case where the transmission control method according to this embodiment is used, in comparison with the conventional example, it is possible to transmit the equivalent of two packets more with a USB packet.

The second embodiment of the present invention has same basic structure as that shown in FIG. 1. Next, a case when a data bus width or FIFO memory size different from that of the above-described example of this embodiment is used, and a case when it is used for the USB slave side (the USB device side) transmission control are described forthwith.

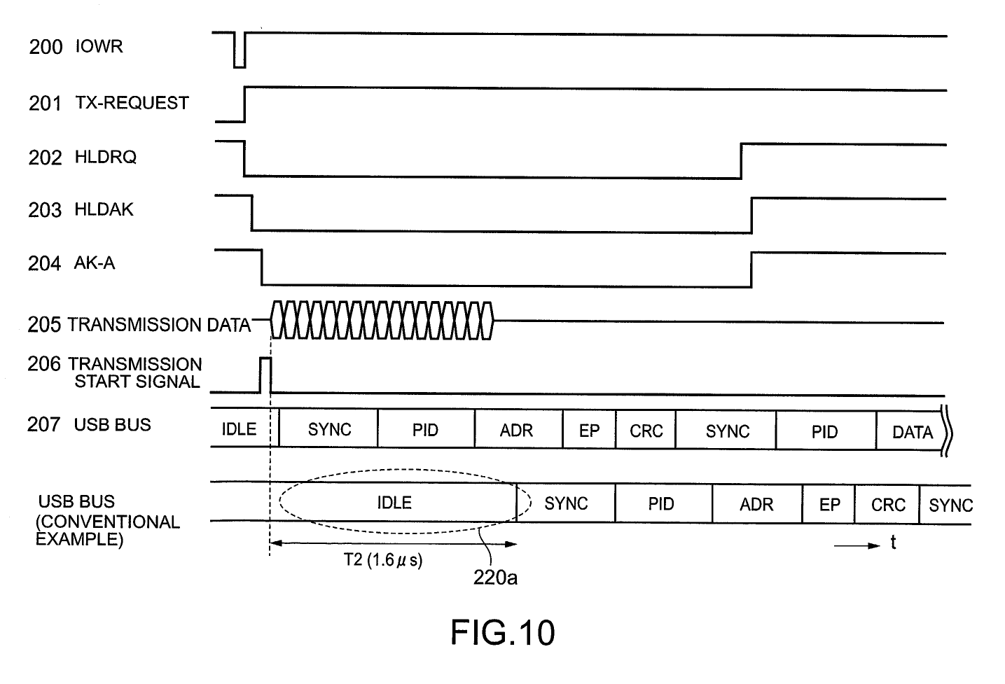

FIG. 10 is a timing chart of the case where a 32-bit data bus or a 32-byte FIFO memory is used in a USB host system in accordance with the second embodiment of the present invention. To begin with, when the CPU 101 makes a transmission request to the USB transmission scheduler circuit 107, transmission operation is commenced. The timing of this correlates to the change in the IOWR signal 200 in FIG. 10. Thereafter, a DMA request 201 is sent from the USB signal scheduler 107 to the DMAC 104, and through the handshake between the bus arbiter 103, which issues bus usage request signal 202, and a CPU 101, which issues a grant signal 203, an AK-A signal 204, which shows that bus usage has been authorized, is output from the bus arbiter 103 to the DMAC 104 and the USB transmission scheduler 107. In response to this signal, data in the external memory 102 is written into FIFO memory 108 by the DMAC 104 and the FIFO controller 106; in parallel with this, a transmission start signal 206 is generated inside the USB transmission scheduler 107 and USB data 207 is sent out to the USB bus 122 by the USB data control circuit 109.

With FIG. 10, in the case where there is a comparison made between data upon the USB bus on the conventional transmission control basis and data of this embodiment, the USB idle state (220a) T2, which is generated from the conventional waiting for a data write into FIFO memory 108, is shown as being 1.6 μs, and it can be understood with this embodiment that this USB idle state 220a does not exist.

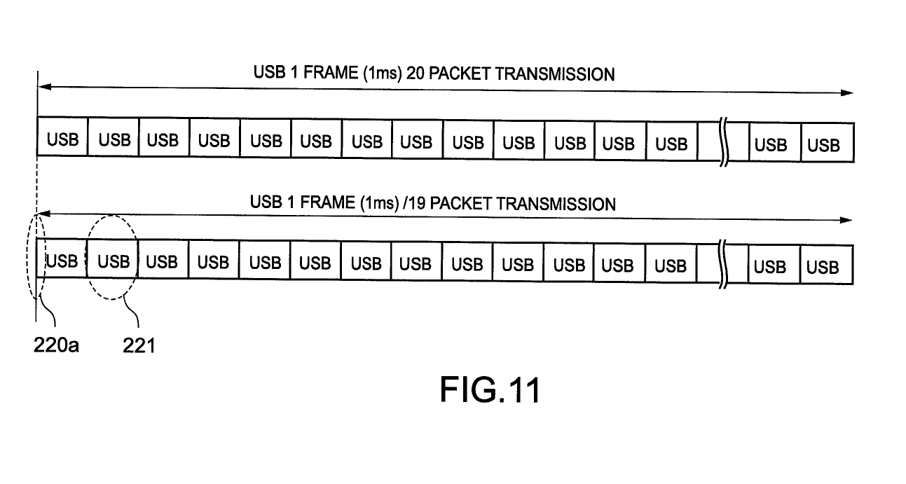

Moreover, FIG. 11 is a timing chart where comparison between transmission in accordance with this embodiment and transmission according to the conventional example is made in terms of how much data can be transmitted within one frame (1 ms) of the USB. It is noted that in this figure, the transmission data length of one USB packet is given as 64 bytes, and immediately after data transmission upon the USB bus is completed, a comparison of the case where the next transmission is activated is performed. In the Figure, 220a denotes the USB bus idle state and 221 denotes a 64-byte USB packet 221. From FIG. 11, in the case where the transmission control method according to this embodiment is used, in comparison with the conventional example, results that allow transmission of the equivalent of one packet more with a USB packet are obtained.

With this embodiment, as with the embodiment shown earlier, the present invention can be implemented in a USB host transmission control circuit that includes FIFO memory if there is means for starting data transmission to the USB bus in conformity with a signal showing that processing for data writing into FIFO memory has commenced, or a signal showing the fact that it is to begin.

In each of the above-mentioned embodiments, results are obtained such as the amount of idle time upon the USB bus being curtailed and the USB bus being able to be used more efficiently; however, by also using a similar configuration on the USB slave side it is possible to efficiently perform data transmission in response to a transmission request from the USB host controller.

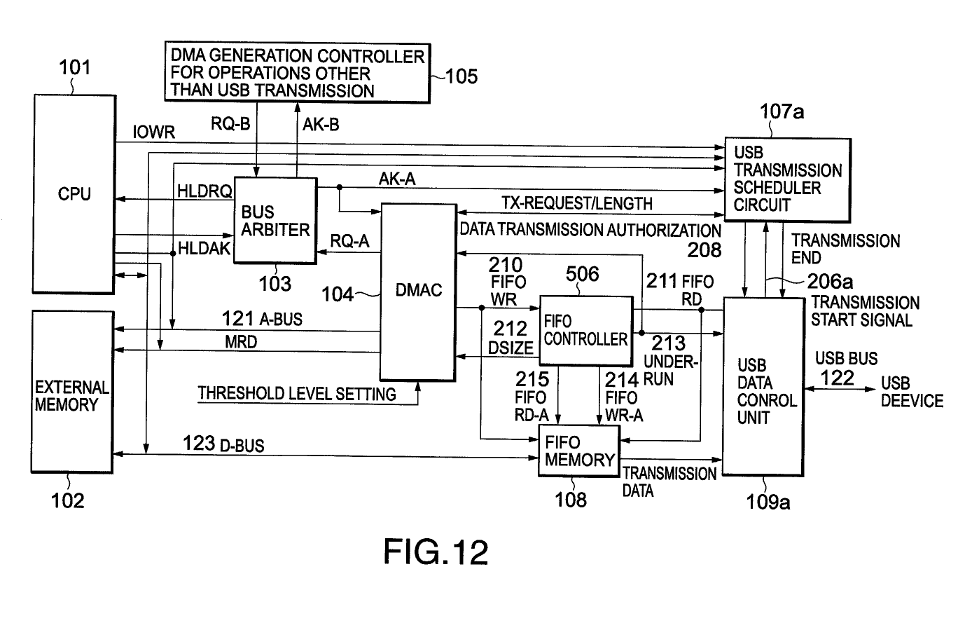

FIG. 12 is a block diagram showing a third embodiment of the present invention, which involves application of the invention to a USB slave side transmission control circuit. On the USB slave side (USB device side), a 16-bit data bus, a 64-byte FIFO memory, and external memory having access time of 100 ns are used. In the Figure, the points differing from the USB host side transmission control circuit of FIG. 1, include 1) the point that the USB data transmission start signal 206a is supplied from the USB data control unit 109a to the USB transmission scheduler circuit 107; 2) the point that there is an added signal which supplies a data transmission grant signal 208 to the USB data control unit 109 from the USB transmission scheduler circuit 107; and 3) the point that an under-run signal 206 is not supplied to the bus arbiter 103.

This is so that, in the case of the USB slave side, data transfer can be performed after the mode of transmission requested from the USB host controller is analyzed by the USB data control unit 109a because which mode of data transfer (reception or transmission) should be performed upon the USB bus is determined by the USB host controller connected over the USB bus.

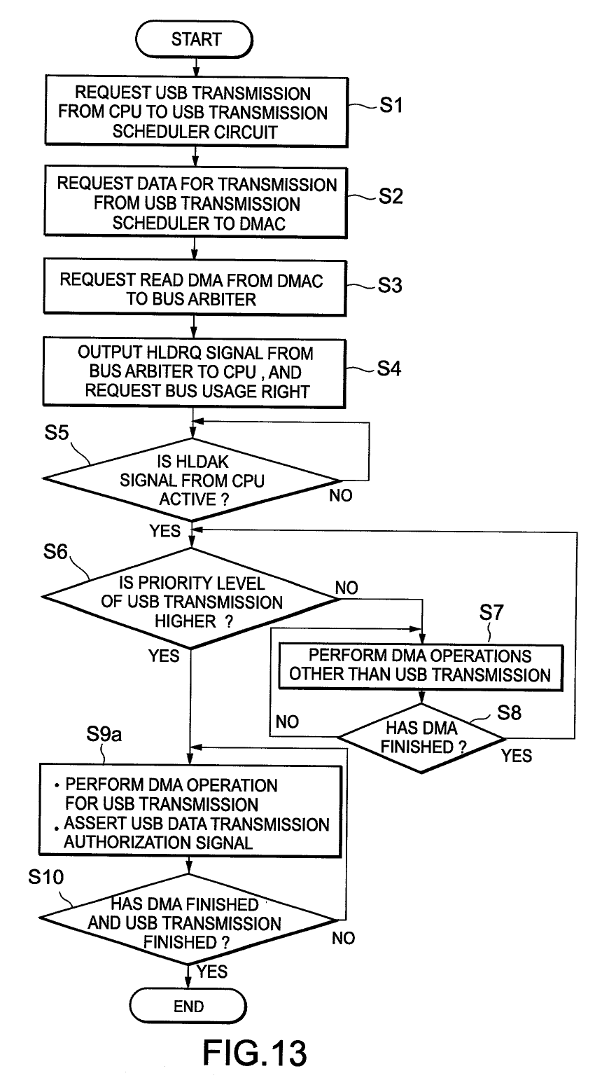

FIG. 13 is a flowchart showing the overall USB slave side transmission control in FIG. 12. Processing up until bus arbiter operation is the same as USB host transmission processing, thus description is omitted. Processing beginning with bus arbiter operation involves the USB transmission scheduler circuit 107a in FIG. 12 supplying, in Step 9a, a data transmission grant signal 208 to the USB data control unit 109a at the same time as the DMA for writing transmission data into FIFO memory 108 is activated. The USB data control unit 109aanalyzes which mode of transfer (transmission or reception) is requested with the signal from the USB host controller supplied from the USB bus, and in the case of transmission transfer, performs any of the following: 1) after the USB packet token phase, transferring data in conformity with the data transfer grant signal 208 supplied from the USB transmission scheduler 107a; 2) outputting the handshake phase, which shows that there is no transmission data; or 3) sending out a Null packet, which shows that there is no data.

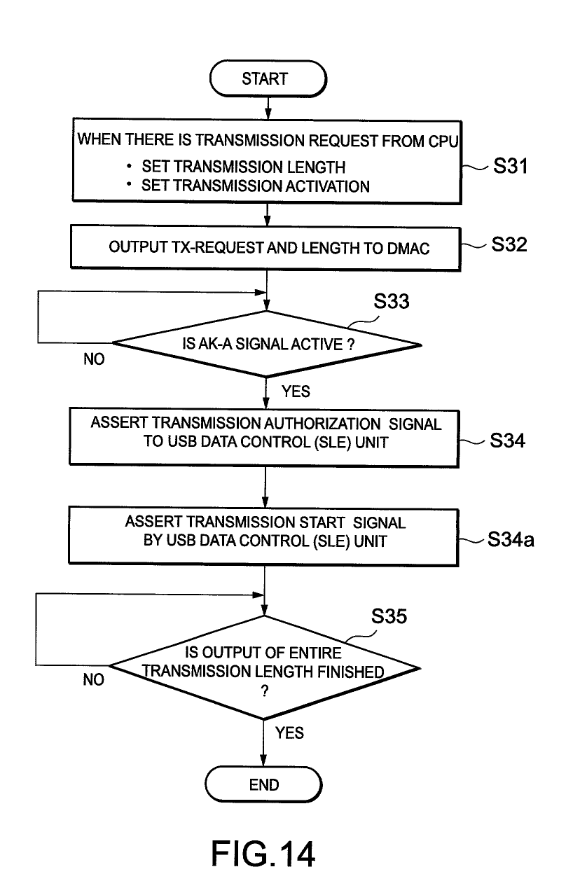

The operational flow of the USB transmission scheduler 107a of FIG. 12 is shown in FIG. 14. To begin with, a DMA request signal is output to the DMAC 104 in response to a transmission activation request from the CPU. Thereafter, (In Step S33) processing waits for the AK-A signal, which shows bus usage rights, to be supplied from the bus arbiter 103, and then after the AK-A signal has been supplied, in Step S34, a transmission grant signal 208 is supplied to the USB data control unit 109a. In accordance with data transmission processing onto the data bus by the USB data control unit 109, in Step S34a a transmission start signal 206 is supplied, and in Step 35 a transmission end signal is supplied, and after one string of operations has finished, processing waits for the next transmission request.

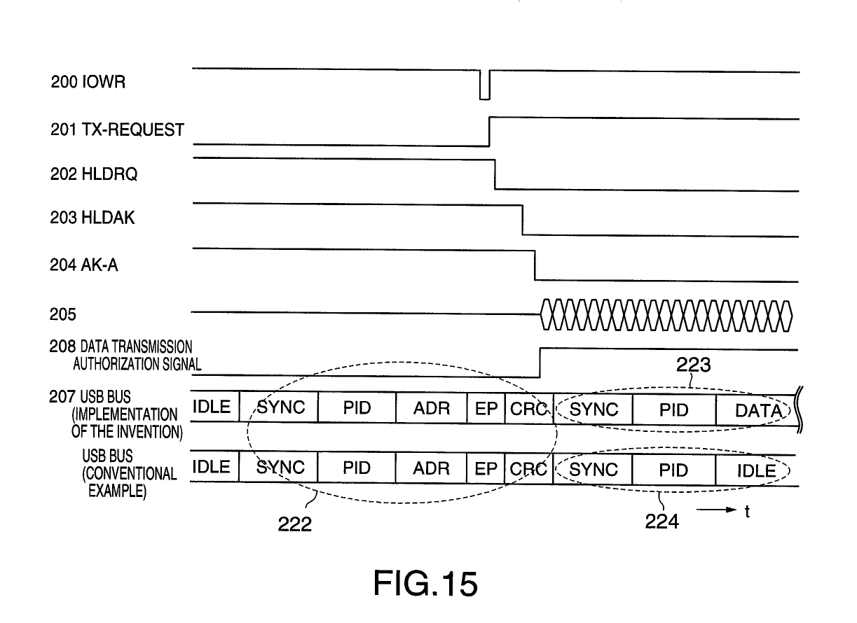

In the USB slave side transmission control block shown in FIG. 12, the operation timing in the case of a data bus D-BUS with a bit width of 16, FIFO memory 508 with a size of 64 bytes, and an external memory 502 having an access time of 100 ns is shown in FIG. 15.

To begin with, DMA operation begins when the CPU 101 of FIG. 12 makes a transmission request to the USB transmission scheduler circuit 107a, and the timing thereof correlates to the change in IOWR signal 200 in FIG. 15. Thereafter, a DMA request 201 is sent from the USB signal scheduler 107 to the DMAC 104, and through the handshake between the bus arbiter 103, which issues a bus usage request signal 202, and the CPU 101, which issues a grant signal 203, an AK-A signal 204, which shows that bus usage has been authorized, is output from the bus arbiter 103 to the DMAC 104 and the USB transmission scheduler 107. With this signal 204, data in the external memory 102 is written into FIFO memory 108 by the DMAC 104 and the FIFO controller 106; in parallel with this, a data transmission grant signal 208 is generated inside the USB transmission scheduler 107 and is supplied to the USB data control circuit 109.

It is noted that in the case where a transmission request comes from the USB host controller via the USB bus in parallel with the above-mentioned operation, the USB data control unit 109a, in addition to supplying a transmission start signal 206 to the USB transmission scheduler circuit 107a, determines whether or not data exists by the level of the data transmission grant signal 208 from the USB transmission scheduler circuit 107a.

Accordingly, with this embodiment, if the DMA for writing data into FIFO memory 108 is activated during supply of the transmission start signal 208 from the USB data control 109a, data is transmitted to the USB bus after the USB token phase. In FIG. 15, comparison is made between data upon the USB bus in the case of this embodiment, and data upon the USB bus in the case of the conventional example. In the case immediately following the token phase 222, which shows the transfer mode, being supplied from the USB host controller, and the DMA for writing data into FIFO memory being activated at that point in time, since data writing into FIFO memory 108 has not been completely finished in the conventional example, a data transmission grant signal 208 is not supplied to the USB data control unit 109.

For that reason, in the conventional example, the handshake phase of the idle state 224 where there is no transmission data or a Null packet showing that there is no data to be output is sent out to the USB bus 122, and data transmission is performed when the next time point where a transmission request from the USB host controller comes; however, in the case of this embodiment, data transmission 223 can be commenced. In FIG. 15, DMA for writing data into FIFO memory 108 is shown in the transmission portion 205, and it is understood that 28 bytes of data is being written at the time point where data is actually being output to the USB bus.

This means that since data can be transmitted during the idle state 224 of the conventional example, approximately twice as much data as the conventional example becomes able to be transmitted. This allows results to be obtained such as being able to reduce transmission of the handshake phase showing that effective data has not been sent or there is no transmission data, and null packets showing that there is no data to be output, in response to a transmission request from the USB host controller to the USB device.

Furthermore, it is possible for a plurality of USB slaves (USB devices) to be connected to the USB host controller so that the segments curtailed through the above-mentioned results can be allocated by the USB host controller for access to the other USB slaves, and a synergistic effect where the efficiency of the buses of the entire USB system is improved can be obtained.

With this embodiment, the present invention can be implemented in a USB slave (USB device) transmission control circuit that includes FIFO memory if there is means for supplying a signal showing data transmission authorization to the USB data control unit in response to a signal showing that processing for data writing into FIFO memory has commenced or a signal showing that the processing is to be started.

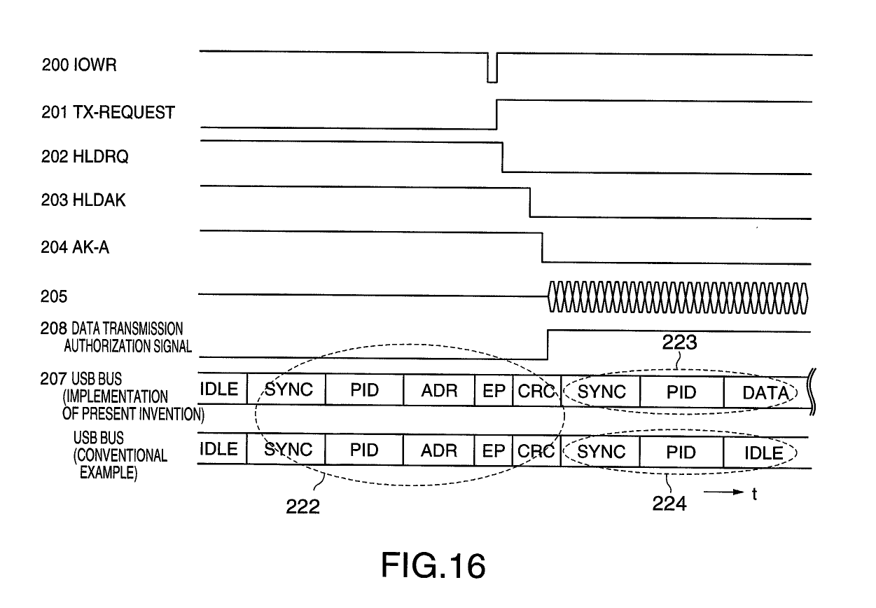

FIG. 16 shows a timing chart in the case where a 16-bit data bus, a 64-byte FIFO memory, and external memory having access time of 50 ns are used in the structural example of USB transmission control on the USB slave side (USB device side) of FIG. 12. The operational sequence in this case is similar to the operation shown earlier, thus its description is omitted.

With this embodiment, in FIG. 16, the transmission portion 205 denotes the DMA for writing data into FIFO memory 108, and it can be understood that 56 bytes of data is being written at the time point where data is actually being output to the USB bus. More specifically, compared with the embodiments shown earlier, with a system capable of using high speed memory as external memory, since the amount written into FIFO memory before data is sent out to the USB bus increases, considering FIFO under-run and the like, a more stable transmission circuit can be configured.

In this embodiment as well, results can be obtained such as being able to reduce transmission of the handshake phase showing that effective data has not been sent or there is no transmission data, and null packets showing that there is no data to be output. Furthermore, it is possible for a plurality of USB slaves (USB devices) to be connected to the USB host controller so that the area curtailed through those results can be allocated by the USB host controller for access to the other USB slaves, and a synergistic effect where the efficiency of the buses of the entire USB system is improved can be obtained.

With this embodiment, as with the third embodiment, the present invention can be implemented in a USB slave (USB device) transmission control circuit that includes FIFO memory as long as there is means for showing data transmission authorization to the USB data control unit in response to a signal showing that processing for data writing into FIFO memory has commenced or a signal showing the fact that the processing is to start.

It is noted that with the above-mentioned embodiments, a USB host transmission control method is described with examples having a data bus width of 16 and a FIFO memory size of 64 bits; however, in a USB host transmission control circuit that includes FIFO memory, as long as there is means for commencing data transmission to the USB bus in response to a signal showing the fact that processing for writing data into FIFO memory has begun, the present invention can be implemented without regard to data bus width or FIFO memory size.

In addition, in the above-mentioned embodiments a memory block is referred to as external memory; however, in the case of memory within LSI, it may even be internal memory. Moreover, with the USB slave side (USB device side) transmission control unit, it is also possible to use the same-configuration.

In accordance with such a configuration of the present invention, since the timing of data transmission commencement to the USB bus is carried out through control performed at the same time as an acknowledge signal that responds to a DMA request for writing transmission data into an internal portion of LSI, it is possible to curtail the idle segments upon the USB bus that conventionally develop before data writing into the transmission FIFO. Accordingly, there are results such as it becoming possible to use this curtailed idle time for other USB data transmission, and the USB bus can be used more efficiently.

Moreover, with the present invention, when writing data into the transmission FIFO, since it is possible to make a bit stuff error develop by supplying an error to the USB data control unit in response to a FIFO under-run error that develops due to the fact that a DMA request was made to wait for a long time, it becomes possible to configure a transmission control system with a small FIFO size and it is possible to curtail LSI chip surface area.

Although the invention has been described with reference to specific embodiments, this description is not meant to be construed in a limiting sense. Various modifications of the disclosed embodiments will become apparent to persons skilled in the art upon reference to the description of the invention. It is therefore contemplated that the appended claims will cover any modifications or embodiments as fall within the true scope of the invention.

What is claimed is:

1. A USB transmission control circuit comprising:
a USB data control unit, which outputs transmission data to a USB bus;
a USB transmission scheduler circuit, which designates said USB data control unit to perform transmission;
FIFO memory, which stores data from an external memory;
a FIFO controller, which controls said FIFO memory;
a bus arbiter, which performs bus usage arbitration;
a DMA controller;
calculation means for calculating the difference between the amount of data written into said FIFO memory by said FIFO controller and the amount of data sent out to said USB bus; and
transmission means for commencing data transmission to said USB bus in conformity with an acknowledge signal from said bus arbiter, which authorizes bus usage, in response to a DMA request for writing data into said FIFO memory.

2. The USB transmission control circuit according to claim 1, wherein in the case where the USB transmission control circuit is in a USB host system, the signal for commencing data transmission is a transmission start authorization signal output to said USB data control unit from said USB transmission scheduler circuit.

3. The USB transmission control circuit according to claim 1, wherein in the case where the USB transmission control circuit is in a USB slave system, the signal for commencing data transmission is a transmission start authorization signal output to said USB transmission scheduler circuit from said USB data control unit.

4. The USB transmission control circuit according to claim 1, comprising:
means for implementing normal data communication over said USB bus by, in the case where determination that an under-run error has developed is made through the results of calculation of the difference between the amount of data written into said FIFO memory and the amount of data transmitted to said USB bus, causing a bit stuff error to develop upon said USB bus, interrupting the transmission packet, and resending transmission data all over again.

5. The USB transmission control circuit according to claim 4, wherein
said FIFO controller comprises an up/down counter, which counts up when there is write access, and counts down when there is read access; wherein an under-run error signal is output when the output of this up/down counter is negative.
